(19) United States
(12) Patent Application Publication
(10) Pub. No.: US 2026/0196826 A1
(43) Pub. Date: Jul. 9, 2026

(54) PILOT TRANSIENT PROTECTION METHOD AND SYSTEM BASED ON OSCILLATION FREQUENCY, AND DEVICE

(71) Applicant: North China Electric Power University, Beijing (CN)

(72) Inventors: Zengping WANG, Beijing (CN); Tong WANG, Beijing (CN); Bingran WANG, Beijing (CN); Zhe LV, Beijing (CN)

(21) Appl. No.: 19/014,892

(22) Filed: Jan. 9, 2025

(51) Int. Cl. H02H 7/26; G06F 17/13; G06F 17/14

(52) U.S. Cl. CPC H02H 7/261; G06F 17/13; G06F 17/142; G06F 17/148

(57) ABSTRACT

A pilot transient protection method and system based on an oscillation frequency, and a device are provided, which relate to the field of line protection. An oscillating component and a power frequency component are separated in a short time window by determining an oscillating characteristic after a fault occurs in a line system, to distinguish the fault based on a relative relation between the oscillating component and the power frequency component and an energy magnitude of the power frequency component. A reliable action when an internal fault occurs is mostly achieved in case of ensuring no mal-operation when an external fault occurs. Therefore, a protection action speed can be effectively increased, and protection reliability is improved. In addition, a requirement for an algorithm is not high, engineering feasibility is very strong, and an application prospect is extensive.

### TECHNICAL FIELD

The present disclosure relates to the field of line protection technologies, and in particular, relates to a pilot transient protection method and system based on an oscillation frequency, and a device.

### BACKGROUND

After a fault occurs in an alternating-current power transmission line in a new power system, the fault feature changes and the original current protection based on the amplitude of the power frequency current is affected and no longer applicable. At the same time, the fault needs to be quickly removed due to an increase in the quantity of power electronic devices. Therefore, it is of great significance to study the protection principle of the alternating-current power transmission line with a high speed, and quickly identify and isolate the fault.

Existing transient protection principles mainly include a time domain waveform-based solution and a boundary effect-based solution. In the time domain waveform-based solution, a fault is only identified based on a polarity difference between currents on two sides of line when an internal fault or external fault occurs. However, the fault feature at an initial stage of a transient state is not limited to polarity, and therefore, reliability of fault identification based on the polarity difference between currents is low. In addition, in the time domain waveform-based solution, the long-time window is required to ensure reliability when waveforms are similar, and therefore, action time is long. However, in the boundary effect-based solution, the fault in case of a poor boundary cannot be processed, and therefore, a high sampling rate is required to obtain the fault feature. At the same time, both the anti-interference capability and the engineering feasibility are poor. It can be learned that the existing transient protection solution generally has problems such as insufficient action speed and poor reliability.

### SUMMARY

To resolve the problem in the background technology, the present disclosure provides a pilot transient protection method and system based on oscillation frequency, and a device, to increase a protection action speed and improve reliability.

To achieve the above objective, the present disclosure provides the following technical solutions.

According to one aspect, the present disclosure provides a pilot transient protection method based on an oscillation frequency, including:
detecting, by protection devices mounted on two sides of a line, a sudden change in current, and determining whether a fault occurs, where the sudden change in current is a change of a differential current at two adjacent sampling points;
when it is determined that the fault occurs, determining a time window length according to a system structure of the line, where the system structure of the line includes a system side impedance, a line parameter, and a topological structure of the line;
decomposing, by using a frequency analysis method, a differential current signal in the line within the time window length into a high-frequency band signal and a low-frequency band signal, to calculate high-frequency energy and low-frequency energy; and
determining that an internal fault occurs when the low-frequency energy is larger than an action threshold and a ratio of the low-frequency energy to the high-frequency energy is larger than a ratio threshold, and allowing the protection device to trip.

Optionally, the detecting, by protection devices mounted on two sides of a line, a sudden change in current, and determining whether a fault occurs specifically includes:
detecting and displaying, by the protection devices mounted on the two sides of the line, phase current waveforms, and taking a vector sum obtained by summing up phase current signals on the two sides of the line as the differential current;
calculating the change

$$\vert \frac{di}{dt} \vert$$

of the differential current at the two adjacent sampling points as the sudden change in current; and
when the sudden change in current is larger than a change threshold Δₛₑₜ, determining that the fault occurs.

Optionally, the determining a time window length according to a system structure of the line specifically includes:
calculating an impedance Z_{Σ} from a fault power source to a system side according to the system structure of the line;
calculating a fault current i₀(s) according to the impedance Z_{Σ}, and analyzing a frequency of a pole in i₀(s).
determining a frequency corresponding to a pole with a smallest imaginary part in all non-power frequency non-direct current (DC) poles as the oscillation frequency f_{ω}; and
determining the time window length according to

$$T \geq \frac{1}{{f}_{ω}} .$$

Optionally, the decomposing, by using a frequency analysis method, a differential current signal in the line within the time window length into a high-frequency band signal and a low-frequency band signal, to calculate high-frequency energy and low-frequency energy specifically includes:
decomposing, by using a wavelet transform method, the differential current signal in the protective line within the time window length T onto a plurality of frequency bands, where a k-layer detail coefficient is Dₖ, and an approximation coefficient is Aₖ.
calculating the high-frequency energy E_{H} by using a formula

$${E}_{H} = {\sum }_{k = 1}^{6} {\sum }_{n = 1}^{N} {{D}_{k} ( n )}^{2} ,$$

where N is a number of discrete signal points in a Dk frequency band, and n represents an n^{th} signal point; and
calculating the low-frequency energy E_{L} by using a formula

$${E}_{L} = {\sum }_{n = 1}^{N} {{A}_{6} ( n )}^{2} ,$$

Optionally, the decomposing, by using a frequency analysis method, a differential current signal in the line within the time window length into a high-frequency band signal and a low-frequency band signal, to calculate high-frequency energy and low-frequency energy specifically includes:
decomposing, by using a fast Fourier transform method, the differential current signal in the protective line within the time window length T into an amplitude Aₙ at each frequency point n;
calculating the high-frequency energy E_{H} by using a formula

$${E}_{H} = {\sum }_{n = 1}^{N} {A}_{n}^{2} ,$$

where N is a number of frequency points after a 0 Hz component is removed by using the fast Fourier transform method; and
calculating the low-frequency energy E_{L} by using a formula

$${E}_{L} = {A}_{0}^{2} .$$

Optionally, the determining that an internal fault occurs when the low-frequency energy is larger than an action threshold and a ratio of the low-frequency energy to the high-frequency energy is larger than a ratio threshold, and allowing the protection device to trip specifically includes:
calculating, by using different frequency analysis methods, different action thresholds E_{Lset}, and setting the ratio threshold Kₛₑₜ at which a weakest case in a transient oscillation process is able to be avoided when an external fault occurs; and
when E_{L}>E_{Lset} and E_{L}>KₛₑₜE_{H}, determining the internal fault occurs and allowing the protection device to trip; otherwise, determining that the external fault occurs and not tripping the protection device.

According to another aspect, the present disclosure provides a pilot transient protection system based on an oscillation frequency, including:
a preliminary fault determining module, configured to: detect, by protection devices mounted on two sides of a line, a sudden change in current, and determine whether a fault occurs, where the sudden change in current is a change of a differential current at two adjacent sampling points;
a time window length calculation module, configured to: when it is determined that the fault occurs, determine a time window length according to a system structure of the line, where the system structure of the line includes a system side impedance, a line parameter, and a topological structure of the line;
a high-frequency and low-frequency energy calculation module, configured to: decompose, by using a frequency analysis method, a differential current signal in the line within the time window length into a high-frequency band signal and a low-frequency band signal, to calculate high-frequency energy and low-frequency energy; and
an internal fault determining module, configured to: determine that an internal fault occurs when the low-frequency energy is larger than an action threshold and a ratio of the low-frequency energy to the high-frequency energy is larger than a ratio threshold, and allow the protection device to trip.

According to still another aspect, the present disclosure further provides an electronic device, including a memory, a processor, and a computer program that is stored in the memory and can be executed by the processor. When the processor executes the computer program, the foregoing pilot transient protection method based on an oscillation frequency is implemented. Optionally, the memory is a non-transitory computer-readable storage medium.

According to specific embodiments provided in the present disclosure, the present disclosure discloses the following technical effects:

The present disclosure provides a pilot transient protection method and system based on an oscillation frequency, and a device. An oscillating component and a power frequency component within a short time window are separated by determining an oscillating characteristic after a fault occurs in the line, to distinguish the fault based on a relative relation between the oscillating component and the power frequency component and an energy magnitude of the power frequency component. An action when an internal fault occurs is mostly achieved in case of ensuring no mal-operation when an external fault occurs. Therefore, a protection action speed can be effectively increased, and protection reliability is improved. In addition, a requirement for an algorithm is not high, engineering feasibility is very strong, and an application prospect is extensive.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic flowchart of a pilot transient protection method based on an oscillation frequency according to the present disclosure;

FIG. 2 is a schematic diagram of a principle of a pilot transient protection method based on an oscillation frequency according to the present disclosure;

FIG. 3 is a schematic diagram of a structural model of a protective line system according to an embodiment of the present disclosure;

FIG. 4 is a schematic diagram of a fault additional network when an external fault occurs according to an embodiment of the present disclosure;

FIG. 5 is a schematic diagram of a lumped parameter line according to an embodiment of the present disclosure;

FIG. 6 shows is a schematic diagram of a curve of an oscillation frequency changing with a distance according to an embodiment of the present disclosure; and

FIG. 7 is a schematic diagram of an action characteristic of a pilot transient protection method according to the present disclosure; and

FIG. 8 is a schematic diagram of maximum energy of a discrete signal according to an embodiment of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other examples obtained by a person of ordinary skill in the art based on the examples of the present disclosure without creative efforts shall fall within the protection scope of the present disclosure.

An objective of the present disclosure is to provide a pilot transient protection (also known as double-ended transient protection) method and system based on an oscillation frequency (namely the dominant frequency corresponding to the line parameter), and a device, to increase a protection action speed and improve reliability.

In order to make the above objective, features and advantages of the present disclosure clearer and more comprehensible, the present disclosure will be further described in detail below in combination with accompanying drawings and particular implementation modes.

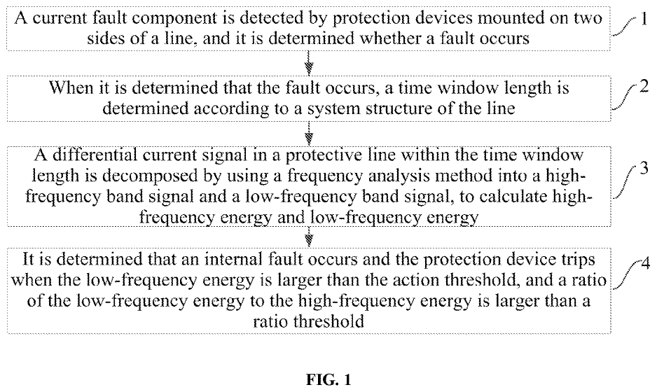

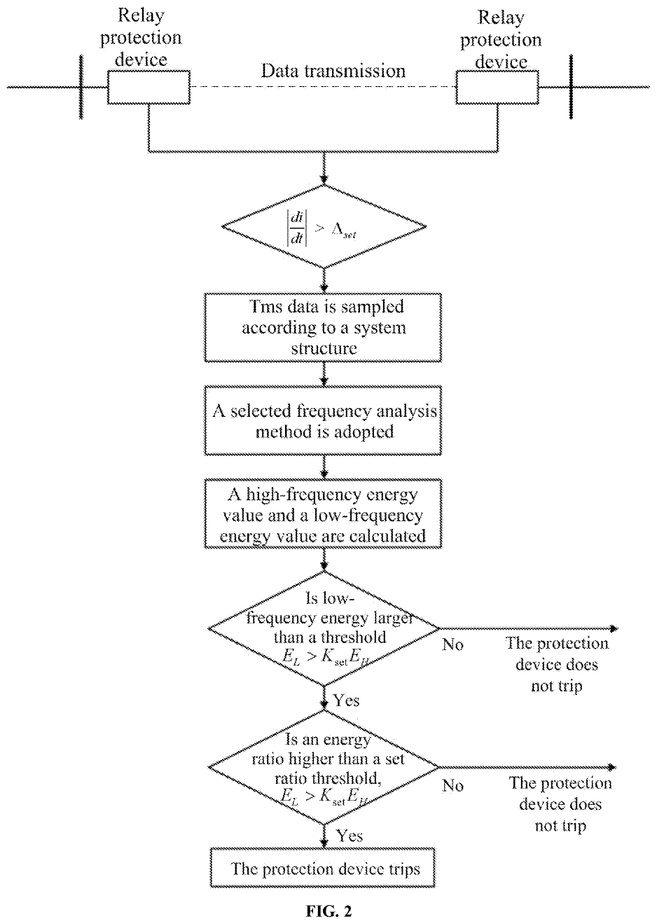

Refer to FIG. 1 and FIG. 2. A core idea of the present disclosure is to identify a fault according to a criterion by calculating high-frequency energy and low-frequency energy of a signal. Therefore, a pilot transient protection method based on an oscillation frequency provided in the present disclosure includes step 1 to step 4.

In step 1, a sudden change in current is detected by protection devices mounted on two sides of a line, and it is determined whether a fault occurs.

According to the present disclosure, it is detected whether a fault occurs based on the sudden change in current (namely, a change of a differential current at two adjacent sampling points). When the sudden change in current exceeds a threshold, it is considered that the system may has a fault, and a protection is started.

Specifically, phase current waveforms are detected and displayed by the protection devices (for example, relay protection devices) mounted on the two sides of the line, and a vector sum obtained by summing up phase current signals on the two sides of the line is taken as the differential current. The change

$$\vert \frac{di}{dt} \vert$$

of the differential current at the two adjacent sampling points is taken as the sudden change in current. When the change exceeds the threshold, that is, when

$$\vert \frac{di}{dt} \vert > {Δ}_{set} ,$$

it is preliminarily determined that a fault occurs, and the protection devices of the line are started.

In step 2, when it is determined that the fault occurs, a time window length is determined according to a system structure of the line.

After the fault occurs, the time window length T is determined according to the system structure, including a system side impedance, a line parameter, and a topological structure of the line.

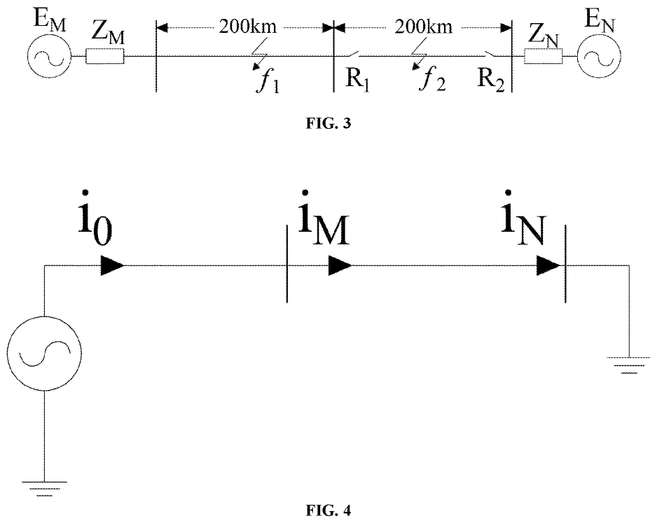

FIG. 3 is a schematic diagram of a structural model of a protective line according to an embodiment of the present disclosure. In the figure, R₁ and R₂ are the protection devices; f₁ and f₂ are two fault points, where f₁ is an external fault point, and f₂ is an internal fault point; and E_{M} represents an M-side power voltage, Z_{M} represents an M-side system impedance, EN represents an N-side power voltage, and Z_{N} represents an N-side system impedance.

A basic principle of the method of the present disclosure is as follows:

A difference between a differential current when the internal fault occurs and a differential current when the external fault occurs is mainly reflected in the power frequency component, where the power frequency component accounts for a high proportion when the internal fault occurs:

$${i}_{n} ( t ) > {i}_{ω} ( t ) + {i}_{T} ( t ) \qquad ( 1 )$$

In the formula (1), iₙ(t) is a power frequency current, i_{ω}(t) is a high-frequency oscillating current, and i_{T}(t) is a reflection and refraction current of a traveling wave.

When a transient process is strong, the power frequency component accounts for a low proportion when the external fault occurs:

$${i}_{n} ( t ) < {i}_{ω} ( t ) + {i}_{T} ( t ) \qquad ( 2 )$$

Formula (2) is not applicable to all external fault occasions. When the transient process is weak (with a small fault initial phase angle and high resistance ground), a relationship of the equation expression is not strictly met. If i_{ω}(t) and i_{T}(t) in a signal are filtered, retained iₙ(t) should meet:

$${i}_{n} ( t ) \leq {i}_{n}^{∞} ( t ) \qquad ( 3 )$$

In the formula (3),

$${i}_{n}^{∞} ( t )$$

represents a steady-state differential current in a fault additional network when the external fault occurs.

When the transient process is strong, the oscillating component is a main part of the signal. After the oscillating component is filtered, an amplitude of the remaining signal is low, but still meets the formula (3). When the internal fault occurs, the oscillating component accounts for a small proportion of the signal. Therefore, after the oscillating component is filtered, the amplitude of the power frequency current signal is still high.

$${i}_{n}^{∞} ( t )$$

is a very small value for the internal fault, and mostly iₙ(t) is far larger than

$${i}_{n}^{∞} ( t )$$

when the internal fault occurs.

Therefore, the external fault and the internal fault can be completely distinguished according to the formulas (1) to (3).

However, a transient protection window is short and frequency precision in the transient protection window cannot reach that of the power frequency component, and therefore, a minimum value of the oscillation frequency in the system needs to be determined through the system structure, to further determine a protection window length. Oscillation in at least one period in an observation window is ensured, and therefore, the oscillating component can be completely separated during spectral analysis. Steps for determining a lowest oscillation frequency and a corresponding time window length are as follows.

In step 2.1, an impedance Z_{Σ} from a fault power source to a system side is determined according to the system structure of the line.

When the external fault occurs, the fault additional network is shown in FIG. 4. In FIG. 4, i₀ is a current at an outlet of the power source, and i_{M} and i_{N} are currents detected by the protection devices on the two sides of the protected line. According to the research, an oscillation frequency of i₀ is consistent with that of i_{M} and i_{N}, that is, oscillation frequencies of the differential currents of the line are consistent. Therefore, a characteristic of the oscillation frequency can be obtained by analyzing a frequency spectrum of i₀.

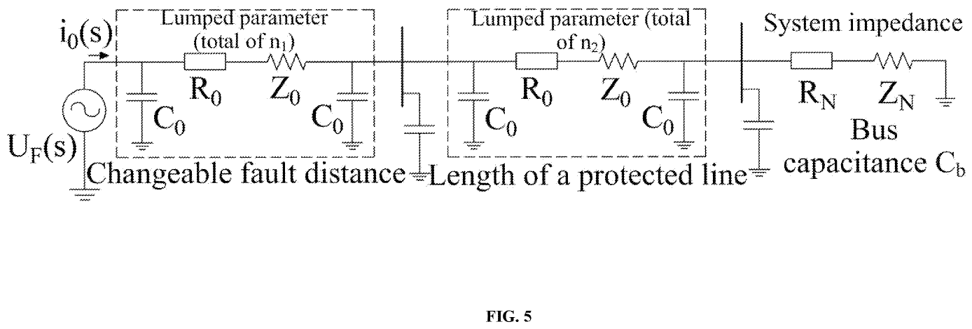

The fault component additional network shown in FIG. 4 can be simplified to obtain a fault network, shown in FIG. 5, represented by a lumped line. In FIG. 5, n represents n Π-shaped circuits of a specific length that are obtained by dividing the line, R₀ represents a resistance equivalent to the length, Z₀ represents a reactance equivalent to the length, C₀ represents a capacitance equivalent to the length, R_{N} and Z_{N} represent system side impedances, and U_{F}(s) represents a fault voltage source.

The impedance Z_{Σ} from the fault power source to the system side can be calculated according to the line structure shown in FIG. 5, as shown in formula (4).

$$\{ \begin{matrix}{Z}_{1} ( s ) = ( {R}_{N} + {Z}_{N} ) // {C}_{0} \\ {Z}_{2} ( s ) = ( {R}_{0} + {Z}_{0} + {Z}_{1} ) // {C}_{0} \\ … \\ {Z}_{Σ} ( s ) = ( {R}_{0} + {Z}_{0} + {Z}_{n} ) // {C}_{0}\end{matrix} \qquad ( 4 )$$

In the formula, Zₙ(s) represents an equivalent impedance of an n^{th} lumped parameter from the system impedance.

In step 2.2, a fault current i₀(s) is calculated according to the impedance Z_{Σ}, and a frequency of a pole in i₀(s) is analyzed.

The fault current may be represented as follows:

$${i}_{0} ( s ) = {U}_{F} ( s ) / {Z}_{Σ} ( s ) \qquad ( 5 )$$

After a transfer function of i₀(s) is obtained, the frequency of the pole in i₀(s) is analyzed.

In step 2.3, a frequency corresponding to a pole with a smallest imaginary part in all non-power frequency non-DC poles is determined as the oscillation frequency f_{ω}.

Among all non-power frequency non-DC poles, the frequency corresponding to the pole with the smallest imaginary part has largest energy in a frequency spectrum, accounts for the highest proportion, and can represent a value of the oscillation frequency f_{ω}.

$${f}_{ω} = \frac{min \{ Im ( {p}_{1} ) , Im ( {p}_{2} ) , … , Im ( {p}_{n} ) \}}{2 π} \qquad ( 6 )$$

In the formula, pₙ represents the pole in the i₀(s), Im represents an imaginary part of the pole, and min represents a minimum value.

Therefore, an oscillation frequency at a fault location can be obtained.

In step 2.4, the time window length

$$T \geq \frac{1}{{f}_{ω}}$$

is determined.

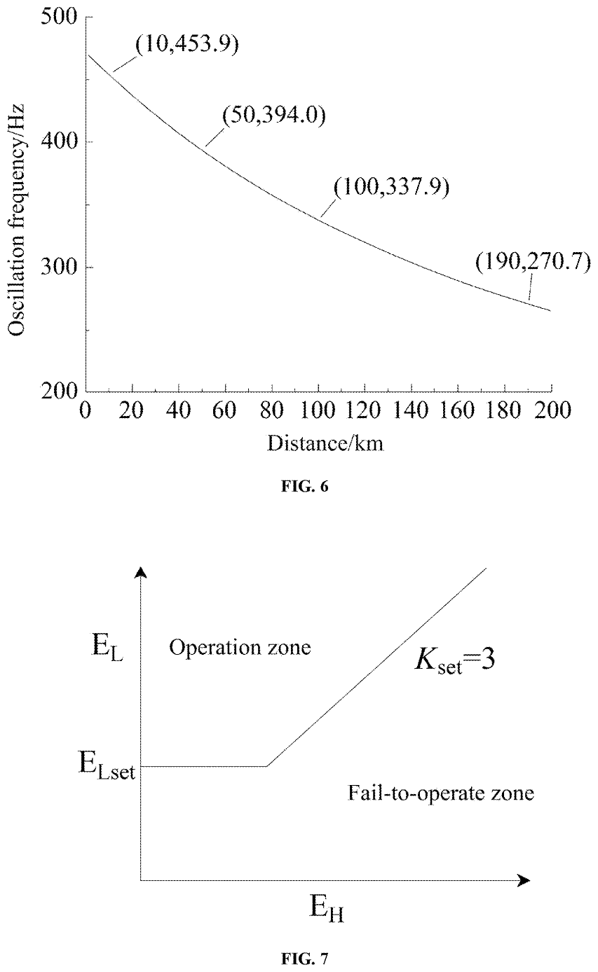

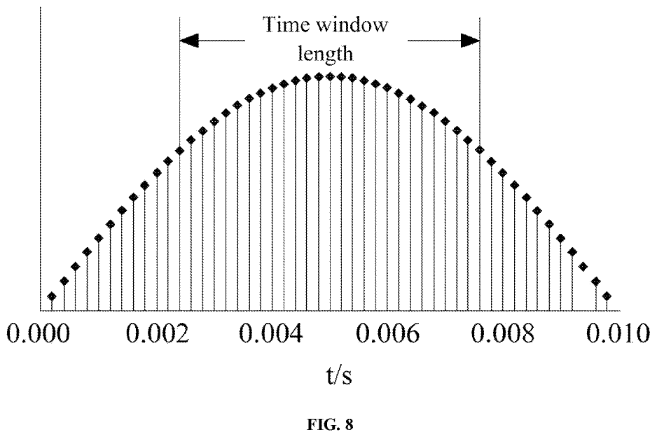

If a lowest oscillation frequency of the system needs to be obtained, the fault location is set as obtaining the minimum value by scanning each point on the line. In FIG. 6, a distance of an x-axis represents a changeable fault distance in FIG. 5. The curve can be obtained by solving an oscillation frequency of each point, and a minimum value of the oscillation frequency is the solved lowest oscillation frequency of the entire system. The lowest oscillation frequency corresponds to a longest oscillation period. As long as a protected time window length is ensured to be larger than the period, the oscillating component and the power frequency component can be ensured to be separated during frequency analysis.

When the protected line has a plurality of adjacent lines, lowest oscillation frequencies in all directions need to be calculated, and the minimum value is selected.

Therefore, the lowest oscillation frequency of the protected line can be calculated based on a line parameter and a system parameter, to design a protection solution. The time window length T in the protection solution should meet:

$$T \geq \frac{1}{{f}_{ω}} \qquad ( 7 )$$

In addition, for a line with an overall length within 400 km, a transient component and the power frequency component can be completely separated based on frequency analysis precision in an observation window length of 5 ms. For a line with an unclear system structure and an overall length less than 400 km, a window length of 5 ms can be selected as the time window length of the protection method.

In step 3, a differential current signal in the line within the time window length is decomposed by using a frequency analysis method into a high-frequency band signal and a low-frequency band signal, to calculate high-frequency energy and low-frequency energy.

Through spectral analysis, the differential current signal in the protective line is decomposed onto different frequency bands, and a sum of frequency band values lower than the lowest oscillation frequency f_{ω} is defined as the low-frequency energy E_{L}, and a sum of remaining frequency band values is defined as the high-frequency energy E_{H} According to formula (1), the following should be met when the internal fault occurs:

$${E}_{L} > {E}_{H} \qquad ( 8 )$$

When the external fault occurs, in a worst case in which an initial fault phase angle is zero, the protection should reliably fail to operate. Therefore, a Kₛₑₜ proportion coefficient is introduced, and an action threshold E_{Lset} of the low-frequency energy is set according to a power frequency feature. An action criterion may be summed up as follows:

$${E}_{L} > {K}_{s e t} {E}_{H} \qquad ( 9 )$$

$${E}_{L} > {E}_{L s e t} \qquad ( 10 )$$

In the formula (9), a fault is substantially identified by using the transient feature of the differential current, and the worst case, namely, the weakest case in the transient oscillation process, should be avoided when the external fault occurs. It is learned that through a large number of simulated tests, a ratio K of the high-frequency energy to the low-frequency energy in the worst case when the external fault occurs does not exceed 1.5. After K is multiplied by a reliability coefficient 2, Kₛₑₜ is equal to 3.

In the formula (10), a fault is substantially identified by using a steady-state characteristic. When the low-frequency energy in a calculated result is lower than the threshold, it is considered that power frequency energy in the differential current is insufficient. When the external fault occurs, no power frequency current is provided by the power source in the line, and therefore, an occurrence possibility of the external fault is excessively high, the protection has no maloperation. For different data analysis methods, E_{Lset} have different setting manners that are described in detail in subsequent analysis.

An action characteristic of the protection method is shown in FIG. 7. The protection method provided in the present disclosure is very strong in adaptability by setting a data time window and a setting value according to the structure of the line. If an oscillation frequency in the system is excessively high, a period that is n times the time window length is set, to improve reliability of the protection.

Herein, two common signal frequency analysis methods are used as data analysis methods: wavelet transform and Fourier transform.

### 3.1. a Protection Method Based on Discrete Wavelet Transform

Wavelet transform is a spectral analysis method in which signals on frequency bands can be resolved. The wavelet transform can be applied with an idea of the protection method provided in the present disclosure to calculate high-frequency energy and low-frequency energy according to frequency bands at different frequencies.

A time-frequency characteristic of a signal can be reflected well by using discrete wavelet transform. The differential current signal is decomposed onto a plurality of frequency bands, and frequency band ranges in which the k-layer detail coefficient Dₖ and the approximation coefficient Aₖ located are as follows:

$${D}_{k} : [ {2}^{- ( k + 1 )} {f}_{s} , {2}^{- k} {f}_{s} ] \qquad ( 11 )$$

$${A}_{k} : [ 0 , {2}^{- ( k + 1 )} {f}_{s} ] \qquad ( 12 )$$

In the formula, fₛ is a sampling frequency. For the protective line in FIG. 4, the lowest oscillation frequency is 220 Hz. Therefore, a fault window length is set to 5 ms (including one entire oscillation period). Discrete wavelet transform with k=6 is performed on the signal. The detail coefficient D₁-D₆ for the previous six layers are frequency components larger than 156 Hz, and a sixth-layer approximation coefficient A₆ is a frequency component of 0 Hz to 156 Hz.

Energy in wavelet transform is defined as a quadratic sum of values of points in each frequency band after reconstruction, and the high-frequency energy and the low-frequency energy can be represented as follows:

$${E}_{H} = {\sum }_{k = 1}^{6} {\sum }_{n = 1}^{N} {{D}_{k} ( n )}^{2} \qquad ( 13 )$$

$${E}_{L} = {\sum }_{n = 1}^{N} {{A}_{6} ( n )}^{2} \qquad ( 14 )$$

N is a number of discrete signal points in a Dₖ frequency band, and n represents an n^{th} signal point.

An expression formula of a maximum power frequency current in the differential current signal after a steady state is analyzed when the external fault occurs to set E_{Lset}. A maximum value of the current in the energy calculation method in the present disclosure is calculated.

An amplitude I_{d} of a maximum steady-state differential current in the fault additional network needs to be obtained to set E_{Lset} A maximum value of the current in the energy calculation method in the present disclosure is calculated. Obviously, when an external three-phase fault occurs and a fault power source is closest to the system impedance, the amplitude of the differential current is a maximum value that is obtained through mathematical calculation or modeling and simulation analysis.

FIG. 9 is a schematic diagram of obtaining maximum energy of a discrete signal in a fixed window length. When a peak value of the discrete signal is achieved at a middle moment of the sampling time window, a maximum value can be achieved.

A quadratic sum is obtained for a power frequency signal within the sampling time window of 5 ms, and the maximum value corresponds to a case in which an initial phase angle of the power frequency component is 45°. In this case, maximum power frequency energy can be obtained.

$${E}_{L s e t} = {K}_{r e l 1} {\sum }_{k = 1}^{N} {[ {K}_{rel 2} {I}_{d} sin ( \frac{π}{4} + 100 π \frac{k}{{f}_{s}} ) ]}^{2} \qquad ( 15 )$$

In the formula, fₛ is a sampling frequency, N is a sampling point, and Kᵣₑₗ is a reliability coefficient. As there is an edge effect in a process of extracting a low-frequency band signal by using the wavelet transform, and there is an error in low-frequency band signal extraction, an amplitude of an extracted signal may be larger than a theoretical value. Kᵣₑₗ₂ is a reliability coefficient when the current amplitude is 2, and Kᵣₑₗ₁ is a reliability coefficient when an energy value is 1.5.

High-frequency energy and low-frequency energy calculated by using wavelet transform as shown in table 1. Conditions for a protection action are that the ratio K is larger than 3, and the low-frequency energy E_{L} is larger than 34.48.

TABLE 1
Calculated results under a wavelet transform framework

| Fault cases | E_{L} | E_{H} | K | Action results |
|---|---|---|---|---|
| External fault | 11.7 | 56.4 | 0.21 | No maloperation |
| External fault | 0.56 | 0.40 | 1.40 | No maloperation |
| Internal fault | 2652.9 | 29.0 | 91.50 | Operate |
| Internal fault | 191.4 | 35.6 | 5.37 | Operate |

In the table, K is the ratio of the low-frequency energy to the high-frequency energy.

It can be learned that in a manner in which a signal is reconstructed by using wavelet transform, signals in different frequency bands can be well separated. The calculated high-frequency energy and low-frequency energy can be used to reliably identify the external fault and the internal fault. In a wavelet transform result, a time-domain characteristic is actually redundant. In this solution, only a characteristic quantity of a signal on a frequency domain is considered, and an operation load will be increased by redundant information.

### 3.2. a Protection Method Based on Fast Fourier Transform

Fourier transform is another spectral analysis method in which amplitudes of frequencies can be resolved. The Fourier transform can be applied with an idea of the protection method provided in the present disclosure.

Spectral distribution of the signals can be calculated by using the Fourier transform, and resolution of a frequency spectrum is determined by a length of a sampling time window. When the lowest oscillation frequency of the system is 220 Hz, a time window length of 5 ms is selected, that is, when the frequency resolution is 200 Hz, frequency spectrum decomposition results are amplitude components corresponding to 0 Hz, 200 Hz, 400 Hz . . . 10 kHz.

$${A}_{m} = {\sum }_{n = 0}^{N - 1} x ( n ) \cdot {e}^{- j 2 π mn / N} \qquad ( 16 )$$

When m=0, the calculated result is as follows:

$${A}_{0} = {\sum }_{n = 0}^{N - 1} x ( n ) \qquad ( 17 )$$

That is, a value at 0 Hz is actually a sum of all values of the signal within the sampling time window.

In the formula, m is a serial number after the decomposition, Aₘ represents an amplitude at the frequency point m after the decomposition, x(n) represents a discrete signal, n represents a sampling point for the discrete signal within the sampling time window, and N represents a total number of discrete signal points.

The transient characteristic has been separated into the rest of frequency points. At most of fault initial phase angles, the 0 Hz component is kept at a high value when the internal fault occurs. When the external fault occurs, a complete oscillation period component is included in the sampling time window, a sum of signal values is equal to zero, and therefore, the amplitude of the 0 Hz component is small. The 0 Hz component is taken as a component representing a power frequency characteristic. However, the disadvantage of approximation processing is that the precision is insufficient. The protection may fail to operate in the worst case when the internal fault occurs.

Energy in the Fourier transform is defined as a sum of values of points in each frequency band, and the high-frequency energy and the low-frequency energy can be represented as follows:

$${E}_{H} = {\sum }_{n = 1}^{N} {A}_{n}^{2} \qquad ( 18 )$$

$${E}_{L} = {A}_{0}^{2} \qquad ( 19 )$$

An action threshold is set according to properties of the Fourier transform, and the low-frequency energy is a sum of current amplitudes. In this case, a maximum value of the maximum power frequency current in the energy calculation method is calculated:

$${E}_{L s e t} = {K}_{r e l 1} {\sum }_{k = 1}^{N} {[ {K}_{rel 2} {I}_{d} sin ( \frac{π}{4} + 100 π \frac{k}{{f}_{s}} ) ]}^{2} \qquad ( 20 )$$

The value of the line system is substituted into the formula (20) to calculate the action threshold E_{Lset} 124.2. Calculated results are shown in Table 2.

TABLE 2
Calculated results under a Fourier transform framework

| Fault cases | E_{L} | E_{H} | K | Action results |
|---|---|---|---|---|
| External fault | 1.40 | 3.40 × 10³ | 4.1 × 10−4 | No malop- |
| | | | | eration |
| External fault | 8.38 | 52.48 | 0.16 | No malo- |
| | | | | peration |
| Internal fault | 2.66 × 10⁵ | 1.52 × 104 | 17.49 | Operate |
| Internal fault | 13.60 | 8.13 × 10³ | 0.0017 | Fail to operate |

It can be learned that the ratio K of the low-frequency energy to the high-frequency energy can also be calculated by calculating a frequency spectrum by using the Fourier transform. When the external fault occurs, the protection has no maloperation. However, the Fourier transform has no sufficient precision to represent the power frequency characteristic, and therefore, there is a dead zone when the internal fault occurs. The Fourier transform is small in computation burden, and a central processing unit (CPU) can be configured to quickly complete computing, increasing a speed of the protection.

In step 4, it is determined that an internal fault occurs when the low-frequency energy is larger than the action threshold and the ratio of the low-frequency energy to the high-frequency energy is larger than a ratio threshold and the protection device is tripped.

Different action thresholds E_{Lset} are calculated using different frequency analysis methods (including the wavelet transform and the Fourier transform), and the ratio threshold Kₛₑₜ is set. At the ratio threshold Kₛₑₜ, a worst case when the external fault occurs, namely, the weakest case in the transient oscillation process, is able to be avoided. In this embodiment of the present disclosure, the ratio threshold set Kₛₑₜ is set to 3. The low-frequency energy E_{L} is compared with the action threshold E_{Lset} If the low-frequency energy E_{L} is larger than the threshold value, namely, E_{L}, E_{Lset}, next step of determining is performed. The ratio K=E_{L}/E_{H} of the low-frequency energy to the high-frequency energy is calculated. If the ratio K is larger than the ratio threshold Kₛₑₜ, namely, E_{L}>KₛₑₜE_{H}, it is determined that the internal fault occurs, and the protection device trips. In other cases, the external fault occurs, and do not trip the protection device.

According to the protection method in the present disclosure, an oscillating component and a power frequency component within a short time window are separated by determining an oscillating characteristic after a fault occurs in the system, to distinguish the external fault and internal fault based on a relative relation between the oscillating component and the power frequency component and an energy magnitude of the power frequency component. An action when the internal fault occurs is mostly achieved in case of ensuring no mal-operation when the external fault occurs. In the protection method in the present disclosure, a protection action speed can be effectively increased, and protection reliability is improved. In addition, a requirement of the protection method for an algorithm is not high, engineering feasibility is very strong, and an application prospect is extensive.

Compared with a protection method based on a boundary effect caused by a bus capacitance of an alternating-current line, the method provided in the present disclosure has better adaptability without depending a high bus capacitance value. Compared with a protection method based on time domain waveform similarity that needs a long time window to ensure reliability, the method provided in the present disclosure does not need a long observation time window based on a transient characteristic within the short time window. Therefore, the method provided in the preset disclosure has a higher action speed. Compared with a travelling wave protection method, the method provided in the present disclosure does not have a high sampling requirement, is not affected by abnormal data, and can be used to accurately identify a fault line. Therefore, a pilot transient protection method based on an oscillation frequency provided in the present disclosure is a transient protection solution with a higher action speed, higher reliability, and implement-feasibility.

Based on the method provided in the present disclosure, the present disclosure provides a pilot transient protection system based on an oscillation frequency, including a preliminary fault determining module, a time window length calculation module, a high-frequency and low-frequency energy calculation module, and an internal fault determining module.

The preliminary fault determining module is configured to: detect, by protection devices mounted on two sides of a line, a sudden change in current, and determine whether a fault occurs, where the sudden change in current is a change of a differential current at two adjacent sampling points.

The time window length calculation module is configured to: when it is determined that the fault occurs, determine a time window length according to a system structure of the line, where the system structure of the line includes a system side impedance, a line parameter, and a topological structure of the line.

The high-frequency and low-frequency energy calculation module is configured to: decompose, by using a frequency analysis method, a differential current signal in the line within the time window length into a high-frequency band signal and a low-frequency band signal, to calculate high-frequency energy and low-frequency energy.

The internal fault determining module is configured to: determine that an internal fault occurs when the low-frequency energy is larger than an action threshold and a ratio of the low-frequency energy to the high-frequency energy is larger than a ratio threshold, and allow the protection device to trip.

Further, the present disclosure further provides an electronic device. The electronic device may include: a processor, a communication interface, a memory and a communication bus. The processor, the communication interface and the memory communicate with one another through the communication bus. The processor may invoke a computer program in the memory, to execute the pilot transient protection method based on an oscillation frequency.

In addition, the computer program in the foregoing memory may be stored in a computer-readable storage medium when the computer program is implemented in a form of a software function unit and is sold or used as an independent product. On the basis of such understanding, the technical solutions of the present disclosure essentially or the part contributing to the prior art may be embodied in a form of a software product. The computer software product is stored in a storage medium, and includes several instructions for enabling a computer device (which may be a personal computer, a server, a network device, etc.) to execute all or some steps of the methods described in the embodiments of the present disclosure. The above storage medium includes any medium that may store program codes, such as a USB flash drive, a removable hard disk, a read-only memory, a random access memory, a magnetic disk and an optical disc.

Embodiments of this description are described in a progressive manner, each embodiment focuses on the difference from other embodiments, and for the same and similar parts between the embodiments, reference may be made to each other. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A pilot transient protection method based on an oscillation frequency, comprising:
detecting, by protection devices mounted on two sides of a line, a sudden change in current, and determining whether a fault occurs, wherein the sudden change in current is a change of a differential current at two adjacent sampling points;
when it is determined that the fault occurs, determining a time window length according to a system structure of the line, wherein the system structure of the line comprises a system side impedance, a line parameter, and a topological structure of the line;
decomposing, by using a frequency analysis method, a differential current signal in the line within the time window length into a high-frequency band signal and a low-frequency band signal, to calculate high-frequency energy and low-frequency energy; and
determining that an internal fault occurs when the low-frequency energy is larger than an action threshold and a ratio of the low-frequency energy to the high-frequency energy is larger than a ratio threshold, and allowing the protection device to trip.

2. The pilot transient protection method based on an oscillation frequency according to claim 1, wherein the detecting, by protection devices mounted on two sides of a line, a sudden change in current, and determining whether a fault occurs specifically comprises:
detecting and displaying, by the protection devices mounted on the two sides of the line, phase current waveforms, and taking a vector sum obtained by summing up phase current signals on the two sides of the line as the differential current;
calculating the change
$$\vert \frac{d i}{d t} \vert$$
of the differential current at the two adjacent sampling points as the sudden change in current; and
when the sudden change in current is larger than a change threshold Δₛₑₜ, determining that the fault occurs.

3. The pilot transient protection method based on an oscillation frequency according to claim 2, wherein the determining a time window length according to a system structure of the line specifically comprises:
calculating an impedance Z_{Σ} from a fault power source to a system side according to the system structure of the line;
calculating a fault current i₀(s) according to the impedance Z_{Σ}, and analyzing a frequency of a pole in i₀(s);
determining a frequency corresponding to a pole with a smallest imaginary part in all non-power frequency non-direct current (DC) poles as the oscillation frequency f_{ω}; and
determining the time window length according to
$$T \geq \frac{1}{{f}_{ω}} .$$

4. The pilot transient protection method based on an oscillation frequency according to claim 3, wherein the decomposing, by using a frequency analysis method, a differential current signal in the line within the time window length into a high-frequency band signal and a low-frequency band signal, to calculate high-frequency energy and low-frequency energy specifically comprises:
decomposing, by using a wavelet transform method, the differential current signal in the protective line within the time window length T onto a plurality of frequency bands, wherein a k-layer detail coefficient is Dₖ, and an approximation coefficient is Aₖ;
calculating the high-frequency energy E_{H} by using a formula
$${E}_{H} = {\sum }_{k = 1}^{6} {\sum }_{n = 1}^{N} {{D}_{k} ( n )}^{2} ,$$
wherein N is a number of discrete signal points in a Dₖ frequency band, and n represents an n^{th} signal point; and
calculating the low-frequency energy E_{L} by using a formula
$${E}_{L} = {\sum }_{n = 1}^{N} {{A}_{6} ( n )}^{2} .$$

5. The pilot transient protection method based on an oscillation frequency according to claim 3, wherein the decomposing, by using a frequency analysis method, a differential current signal in the line within the time window length into a high-frequency band signal and a low-frequency band signal, to calculate high-frequency energy and low-frequency energy specifically comprises:
decomposing, by using a fast Fourier transform method, the differential current signal in the protective line within the time window length T into an amplitude Aₙ at each frequency point n;
calculating the high-frequency energy E_{H} by using a formula
$${E}_{H} = {\sum }_{n = 1}^{N} {A}_{n}^{2} ,$$
wherein N is a number of frequency points after a 0 Hz component is removed by using the fast Fourier transform method; and
calculating the low-frequency energy E_{L} by using a formula
$${E}_{L} = {A}_{0}^{2} .$$

6. The pilot transient protection method based on an oscillation frequency according to claim 4, wherein the determining that an internal fault occurs when the low-frequency energy is larger than an action threshold and a ratio of the low-frequency energy to the high-frequency energy is larger than a ratio threshold, and allowing the protection device to trip specifically comprises:
calculating, by using different frequency analysis methods, different action thresholds E_{Lset}, and setting the ratio threshold Kₛₑₜ at which a weakest case in a transient oscillation process is able to be avoided when an external fault occurs; and
when E_{L}<E_{Lset} and E_{L}>KₛₑₜE_{H}, determining the internal fault occurs and allowing the protection device to trip; otherwise, determining that the external fault occurs and not tripping the protection device.

7. A pilot transient protection system based on an oscillation frequency, comprising:
a preliminary fault determining module, configured to: detect, by protection devices mounted on two sides of a line, a sudden change in current, and determine whether a fault occurs, wherein the sudden change in current is a change of a differential current at two adjacent sampling points;
a time window length calculation module, configured to: when it is determined that the fault occurs, determine a time window length according to a system structure of the line, wherein the system structure of the line comprises a system side impedance, a line parameter, and a topological structure of the line;
a high-frequency and low-frequency energy calculation module, configured to: decompose, by using a frequency analysis method, a differential current signal in the line within the time window length into a high-frequency band signal and a low-frequency band signal, to calculate high-frequency energy and low-frequency energy; and
an internal fault determining module, configured to: determine that an internal fault occurs when the low-frequency energy is larger than an action threshold and a ratio of the low-frequency energy to the high-frequency energy is larger than a ratio threshold, and allow the protection device to trip.

8. An electronic device, comprising a memory, a processor, and a computer program that is stored in the memory and is able to be executed by the processor, wherein when the processor executes the computer program, the pilot transient protection system based on an oscillation frequency according to claim 1 is implemented.

9. The electronic device according to claim 8, wherein the memory is a non-transitory computer-readable storage medium.

10. The pilot transient protection method based on an oscillation frequency according to claim 5, wherein the determining that an internal fault occurs when the low-frequency energy is larger than an action threshold and a ratio of the low-frequency energy to the high-frequency energy is larger than a ratio threshold, and allowing the protection device to trip specifically comprises:
calculating, by using different frequency analysis methods, different action thresholds E_{Lset}, and setting the ratio threshold Kₛₑₜ at which a weakest case in a transient oscillation process is able to be avoided when an external fault occurs; and
when E_{L}>E_{Lset} and E_{L}>KₛₑₜE_{H}, determining the internal fault occurs and allowing the protection device to trip; otherwise, determining that the external fault occurs and not tripping the protection device.

11. The electronic device according to claim 8, wherein the detecting, by protection devices mounted on two sides of a line, a sudden change in current, and determining whether a fault occurs specifically comprises:
detecting and displaying, by the protection devices mounted on the two sides of the line, phase current waveforms, and taking a vector sum obtained by summing up phase current signals on the two sides of the line as the differential current;
calculating the change
$$\vert \frac{d i}{d t} \vert$$
of the differential current at the two adjacent sampling points as the sudden change in current; and
when the sudden change in current is larger than a change threshold Δₛₑₜ, determining that the fault occurs.

12. The electronic device according to claim 11, wherein the determining a time window length according to a system structure of the line specifically comprises:
calculating an impedance Z_{Σ} from a fault power source to a system side according to the system structure of the line;
calculating a fault current i₀(s) according to the impedance Z_{Σ}, and analyzing a frequency of a pole in i₀(s);
determining a frequency corresponding to a pole with a smallest imaginary part in all non-power frequency non-direct current (DC) poles as the oscillation frequency f_{ω}; and
determining the time window length according to
$$T \geq \frac{1}{{f}_{ω}} .$$

13. The electronic device according to claim 12, wherein the decomposing, by using a frequency analysis method, a differential current signal in the line within the time window length into a high-frequency band signal and a low-frequency band signal, to calculate high-frequency energy and low-frequency energy specifically comprises:
decomposing, by using a wavelet transform method, the differential current signal in the protective line within the time window length T onto a plurality of frequency bands, wherein a k-layer detail coefficient is Dₖ, and an approximation coefficient is Aₖ;
calculating the high-frequency energy E_{H} by using a formula
$${E}_{H} = {\sum }_{k = 1}^{6} {\sum }_{n = 1}^{N} {{D}_{k} ( n )}^{2} ,$$
wherein N is a number of discrete signal points in a Dₖ frequency band, and n represents an n^{th} signal point; and
calculating the low-frequency energy E_{L} by using a formula
$${E}_{L} = {\sum }_{n = 1}^{N} {{A}_{6} ( n )}^{2} .$$

14. The electronic device according to claim 12, wherein the decomposing, by using a frequency analysis method, a differential current signal in the line within the time window length into a high-frequency band signal and a low-frequency band signal, to calculate high-frequency energy and low-frequency energy specifically comprises:
decomposing, by using a fast Fourier transform method, the differential current signal in the protective line within the time window length T into an amplitude Aₙ at each frequency point n;
calculating the high-frequency energy E_{H} by using a formula
$${E}_{H} = {\sum }_{n = 1}^{N} {A}_{n}^{2} ,$$
wherein N is a number of frequency points after a 0 Hz component is removed by using the fast Fourier transform method; and
calculating the low-frequency energy E_{L} by using a formula
$${E}_{L} = {A}_{0}^{2} .$$

15. The electronic device according to claim 11, wherein the memory is a non-transitory computer-readable storage medium.

16. The electronic device according to claim 12, wherein the memory is a non-transitory computer-readable storage medium.

17. The electronic device according to claim 13, wherein the memory is a non-transitory computer-readable storage medium.

18. The electronic device according to claim 14, wherein the memory is a non-transitory computer-readable storage medium.
